(19) United States
(12) Patent Application Publication
(10) Pub. No.: US 2004/0267532 A1
(43) Pub. Date: Dec. 30, 2004

(54) Audio encoder

(75) Inventor: Alastair Black, London (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/880,292

(22) Filed: Jun. 29, 2004

(30) Foreign Application Priority Data
Jun. 30, 2003 (GB) 0315239.4

(51) Int. Cl. G10L 19/00

(52) U.S. Cl. 704/268

(57) ABSTRACT

An audio encoder, for encoding an input signal, comprising:

a speech encoder for encoding the input signal to produce a synthetic signal;

a delay compensator for delaying the input signal;

combination means for combining the delayed input signal and synthetic signal into a combined signal; and

means for audio encoding the combined signal.

Traditionally, audio coding techniques such as Advanced Audio Coding (AAC), the ISO/IEC MPEG family (-1, -2, -4), Lucent Technologies PAC/EPAC/MPAC and Sony ATRAC, have typically employed a perceptual model to code an audio signal. However, these codec instructions are not efficient at coding speech type audio signals. Typically, the quality achieved from an audio codec, for a speech signal, is inferior to that which is achieved with a speech codec operating at a lower bit rate.

Consequently there has been considerable interest in combining speech and audio coding techniques in order to achieve a generic coding structure, which is capable of coding both categories of signal with a high quality.

One such solution is the MPEG-4 Scalable General Audio Coder. It consists of a cascade of speech and audio coding sections. However, a problem with this system is that the speech codec must be specially designed and a standard mobile communications speech codec cannot be used.

A number of advanced speech codecs have been developed for use in mobile cellular telecommunications. These include the Wide Band Advanced Multi Rate Codec (WB-AMR) standard, the Advanced Multi Rate Codec (AMR) standard and the Enhanced Full Rate Codec (EFR) standard specified by the Third Generation partnership project (3GPP) as well as other voice codec standards specified by other standard setting bodies. These speech codecs are generally bit exact and they must be implemented as specified by the standard setting bodies.

It would be desirable to combine a standard mobile cellular telecommunications speech codec with audio coding in order to achieve a generic coding structure, which is capable of coding both categories of signal with a high quality.

The inventor has realised that most mobile cellular telecommunications speech encoders use infinite impulse response (IIR) high pass filtering at the front end in order to remove any unwanted artefacts from the speech signal before it is coded. However, this results in a non-linear delay between the original input signal and the encoded synthetic speech output. The inventor has therefore realised that in a generic coding structure that uses a cascade of speech and audio coding sections, it will be necessary to compensate for this non-linear delay.

According to one aspect of the present invention there is provided an audio encoder, for encoding an input signal, comprising: a speech encoder for encoding the input signal to produce a synthetic signal; a delay compensator for delaying the input signal; combination means for combining the delayed input signal and synthetic signal into a combined signal; and means for audio encoding the combined signal.

According to another aspect of the present invention there is provided an audio encoder for encoding an input signal comprising a speech encoder for encoding the input signal; a non-linear delay compensator for delaying the input signal; and an audio encoder in series with the delay compensator, wherein the series combination of the delay compensator and audio encoder is in cascade with the speech encoder.

According to a further aspect of the present invention there is provided a method of using an extant speech encoder in an audio encoder comprising the steps of: encoding an input signal using the speech encoder to produce a synthetic signal; delaying the input signal; combining the delayed input signal and the synthetic signal into a combined signal; and audio encoding the combined signal.

For a better understanding of the present invention reference will now be made by way of example only to the accompanying figures in which:

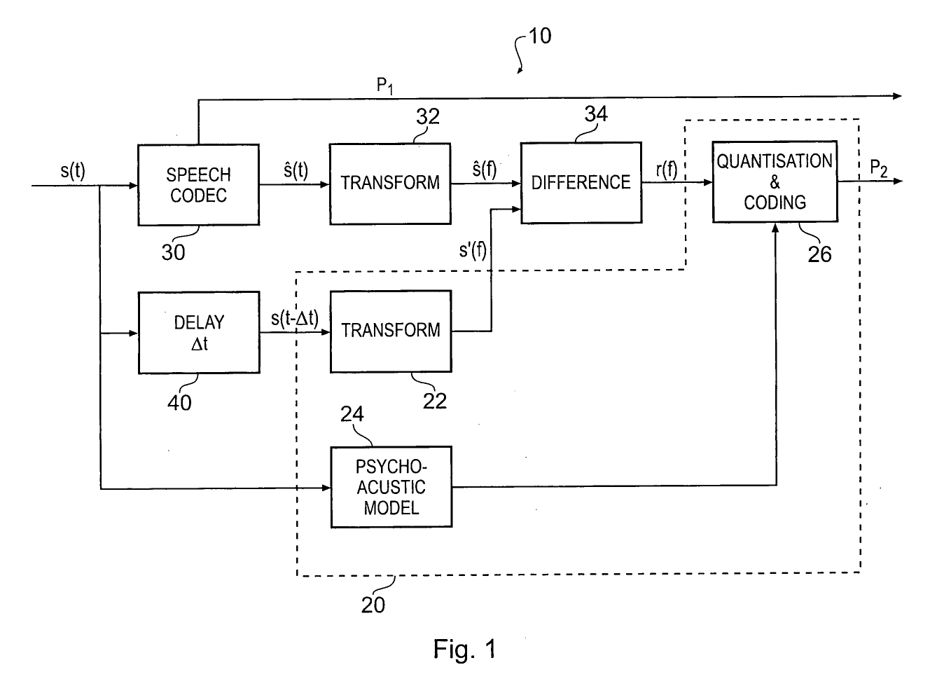

FIG. 1 illustrates a generic coding system according to one embodiment of the present invention;

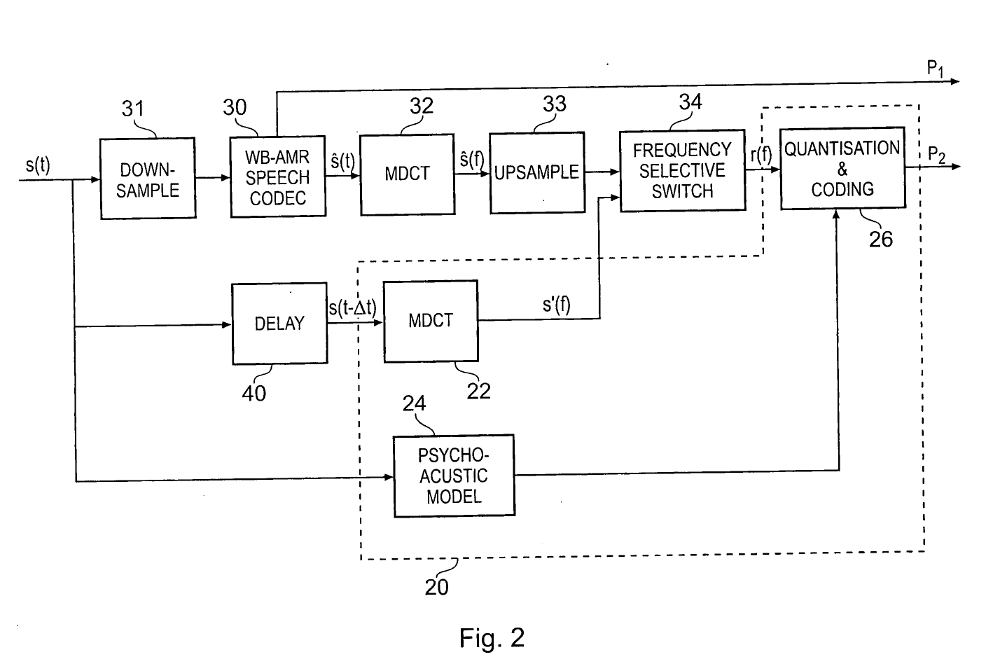

FIG. 2 illustrates an audio coding system including a wide band AMR speech codec; and

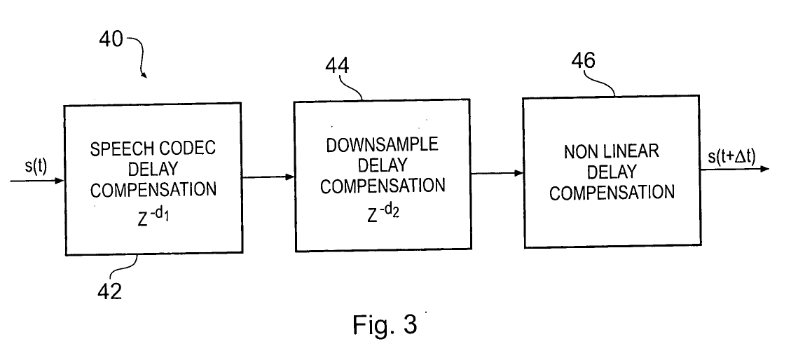

FIG. 3 illustrates the delay compensation blocks of FIG. 1 and FIG. 2 in more detail.

FIG. 1 illustrates a generic audio coding system 10. It includes an audio codec portion 20, which is connected in cascade with a speech codec portion 30.

The speech codec 30 operates in accordance with a mobile cellular telecommunications standard such as WB-AMR, AMR, EFR etc. The speech codec 30 will include an infinite impulse response (IIR) filter at its front end, which filters an input signal s(t) before it is coded to produce the output synthetic signal ŝ(t) and the output parameters p1. The speech codec 30 will generally operate at a lower sampling rate than the audio codec portion 20 and the input signal s(t) may be down-sampled before it is inputted to the speech codec 30.

The output synthetic signal ŝ(t) is provided to a transformation block 32, which transforms the synthetic output signal ŝ(t) from the time domain into the frequency domain. The synthetic output signal ŝ(t) output by the transformation block 32 is provided as a first input to a difference block 34. The transformation block, may for example use a modified discreet cosine transform (MDCT).

The difference block 34 creates a residual signal r(f) from the signals provided to its first input and its second input. The difference block 34 may, for example, be a frequency selective switch (FSS) which subtracts the signal at one input from the signal at the other input.

The residual signal r(f) is provided as a first input to a quantisation and coding block 26 of the audio codec portion 20. The second input to the quantisation and coding block 26 is a signal based upon the psychoacoustic modelling of the input signal s(t). The input signal s(t) is provided to a psychoacoustic modelling block 24 of the audio codec portion 20, the output of which is provided to the quantisation and coding block 26. The quantisation and coding block 26 produces audio coding parameters p2.

The second input to the difference block 34 is compensated so that the signals provided to the first and second inputs of the difference block are time aligned. The input signal s(t) is provided to a delay compensation block 40, which compensates for the effect of delays, introduced by the speech codec 30, on the signal provided to the first input to the difference block 34. . The delayed signal s(t−δt) is provided to a second transformation block 22 in the audio codec portion 20. The transformation block 22 transforms the delayed input signal s(t−δt) from the time domain into the frequency domain to produce the signal s′(f) which is provided as the second input to the difference block 34. The second transformation block 22 may form a modified discreet cosine transform (MDCT).

If the input signal s(t) was down-sampled before its input to the speech codec 30, the output from the first transformation block 32 is up-sampled before it is provided as the first input to the difference block 34. Consequently, the first and second inputs to the difference block 34 have the same sampling rates.

The delay compensation block 40 ensures that the first and second inputs to the difference block 34 are time aligned.

FIG. 2 illustrates an audio coding system 10 in which the speech codec portion 30 is the Wide Band Advanced Multi Rate speech codec (WB-AMR) as specified by 3GPP and includes an infinite impulse response filter at its front end. The audio codec portion 20, in this example, uses Advanced Audio Coding (AAC) as defined by MPEG. This figure explicitly illustrates a down-sampling block 31 before the speech codec 30, which re-samples the input signal s(t). The input signal s(t) has a bit rate of 24 kHz. The down-sampling block 31 re-samples the input signal s(t) at a rate of 16 kHz. This is the required bit rate for the WB-AMR speech codec 30. The audio coding system 10 of FIG. 2 also explicitly illustrates an up-sampling block 33 after the speech codec 30, which re-samples the synthetic signal ŝ(t) from 16 kHz to 24 kHz before it is passed to the frequency selective switch 34. The use of a different speech codec 30 may require the use of different up-sampling and down-sampling rates. For example, the Enhanced Full Rate (EFR) codec, originally specified in GSM and now by 3GPP, operates at a rate of 8 kHz. The input signal s(t) is therefore down-sampled from 24 kHz to 8 kHz and the synthetic signal is up-sampled from 8 kHz to 24 kHz.

FIG. 3 illustrates in more detail the delay compensation block 43. It includes in series three separate delay blocks. Although the blocks are shown in a particular order, they may be rearranged in any order.

A first delay block 42 compensates for the unit sample delay through the speech codec 30. This delay will be dependent upon the type of speech codec used. For WB-AMR it is set to 135.

A second delay block 44 is used to compensate for the re-sampling of the synthetic signal by the up-sampler 33 of FIG. 2. In the example of FIG. 2, the up-sampling is from 16 kHz to 24 kHz and the delay to be compensated for is consequently a half sample delay. Therefore D2 is set to 0.5. The half sample delay may be implemented as a Finite Impulse Response (FIR) filter.

The third delay block 46 compensates for the non linear delay produced by the IIR filter of the speech codec 30. It may be modelled as a cascade of two IIR filters. The delay transform of the delay block is given by:

$$Delay Transform = {z}^{- d1} \cdot {z}^{- d2} \cdot {\prod }_{i = 0}^{I} \frac{{b}_{0} + {b}_{1} {z}^{- 1} + {b}_{2} {z}^{- 2}}{1 - {c}_{1} {z}^{- 1} - {c}_{2} {z}^{- 2}}$$

The coefficient of the third delay block 46 may be calculated, for example using the Chebyshev Type II technique. For the example of FIG. 2, they may be b₀=0.9944, b₁=−1.9887, b₂=0.9944, c₁=1.9887 and c₂=−0.9889. These coefficients are designed for 24 kHz sampling and compensate for the front end bypass filter which is present in most standard speech codecs.

Although embodiments of the present invention have been described in the preceding paragraphs with reference to various examples, it should be appreciated that modifications to the examples given can be made without departing from the scope of the invention as claimed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An audio encoder, for encoding an input signal, comprising:
a speech encoder for encoding the input signal to produce a synthetic signal;
a non-linear delay compensator for delaying the input signal;
combination means for combining the delayed input signal and synthetic signal into a combined signal; and
means for audio encoding the combined signal.

2. An audio encoder as claimed in claim 1, wherein the combination means includes means for transforming the delayed input signal from the time domain to the frequency domain; means for transforming the synthetic signal from the time domain to the frequency domain; and means for obtaining the difference between the transformed delayed input signal and the transformed synthetic signal.

3. An audio encoder as claimed in claim 1, further comprising:
first conversion means for converting the input signal from a first bit rate to a second bit rate before speech encoding and second conversion means for converting the synthetic signal from the second bit rate to the first bit rate.

4. An audio encoder as claimed in claim 1 wherein the speech encoder includes a non-linear filter.

5. An audio encoder as claimed in claim 1, wherein the speech encoder includes an infinite impulse response filter.

6. An audio encoder as claimed in claim 1, wherein the speech encoder complies with a cellular telecommunications standard.

7. An audio encoder as claimed in claim 1, wherein the speech encoder operates at a second sampling rate, less that the sampling rate of operation of the audio codec.

8. An audio encoder as claimed in claim 1, wherein the delay compensator compensates for a delay introduced by the speech encoder.

9. An audio encoder as claimed in claim 1, wherein the delay compensator includes a first time shift component compensating for a predictive nature of the speech encoder.

10. An audio encoder as claimed in claim 1, wherein the delay compensator includes a second time shift component compensating for bit rate conversion.

11. An audio encoder as claimed in claim 9, wherein the delay compensator includes a non-linear component.

12. An audio encoder for encoding an input signal comprising
a speech encoder for encoding the input signal;
a non-linear delay compensator for delaying the input signal; and
an audio encoder in series with the delay compensator, wherein the series combination of the delay compensator and audio encoder is in cascade with the speech encoder.

13. A method of using an extant speech encoder in an audio encoder comprising the steps of:
encoding an input signal using the speech encoder including a non-linear filter to produce a synthetic signal;
delaying the input signal to compensate for a delay introduced by the speech encoder;
combining the delayed input signal and the synthetic signal into a combined signal; and
audio encoding the combined signal.

14. A method as claimed in claim 13, wherein the step of combining includes transforming the delayed input signal from the time domain to the frequency domain; transforming the synthetic signal from the time domain to the frequency domain; and obtaining the difference between the transformed delayed input signal and the transformed synthetic signal.

15. A method as claimed in claim 13, further comprising the steps of converting the input signal from a first bit rate to a second bit rate before the encoding step and converting the synthetic signal from the second bit rate to the first bit rate before the combining step.

16. A method as claimed in claim 13, wherein the step of encoding using the speech encoder is performed at a second bit rate, less that the bit rate of audio encoding.

17. A method as claimed in claim 13, wherein the step of delaying compensates for a predictive nature of the speech encoder.

18. A method as claimed in claim 13, wherein the step of delaying compensates for bit rate conversion of the synthetic signal.

19. A method as claimed in claim 13, wherein the step of delaying compensates for a non-linear delay introduced by the speech encoder.
